(19) United States
(12) Patent Application Publication
(10) Pub. No.: US 2022/0205351 A1
(43) Pub. Date: Jun. 30, 2022

(54) DRILLING DATA CORRECTION WITH MACHINE LEARNING AND RULES-BASED PREDICTIONS

(71) Applicant: Landmark Graphics Corporation, Houston, TX (US)

(72) Inventors: Shreshth Srivastav, Noida (IN); Lloyd Maddock, London (GB); Misael Luis Santana, Katy, TX (US); Ashish Kishore Fatnani, Bengaluru (IN); Shashwat Verma, Bengaluru (IN); Sridharan Vallabhaneni, Bangalore (IN)

(21) Appl. No.: 17/134,738

(22) Filed: Dec. 28, 2020

(51) Int. Cl. E21B 44/00; E21B 47/12; G06N 20/00; G06K 9/62

(52) U.S. Cl. CPC E21B 44/00; G06K 9/6256; G06N 20/00; E21B 47/138

(57) ABSTRACT

A drilling data correction system corrects drilling data entries in high-importance drilling data segments using machine learning and rules-based drilling models. A data importance analyzer identifies high-importance data segments in incoming drilling data. The drilling data correction system inputs features of drilling data into machine learning drilling models and rules-based drilling models trained to predict the high-importance data segments. Predictions from the machine learning drilling models and rules-based drilling models are presented to a user based on drilling data prediction criteria. The machine learning drilling data predictions are used to automatically correct the high-importance data segments, or the user chooses between machine learning drilling data predictions and rules-based drilling data predictions to correct the high-importance drilling data segment.

### TECHNICAL FIELD

The disclosure generally relates to the field of data correction and to predictive modeling for drilling operations.

### BACKGROUND

Different types of predictive models involve both statistical tools such as machine learning and domain-level rules that can be applied to predict outcomes. Machine learning predictive models include clustering, random forests, regression models, support vector machines, neural networks, etc. Rules-based predictive models vary significantly based on the domain to which they are applied and often incorporate expert knowledge for known outcomes in the respective domain.

### BRIEF DESCRIPTION OF THE DRAWINGS

Embodiments of the disclosure may be better understood by referencing the accompanying drawings.

FIG. 1 is a schematic diagram of an example drilling data correction system for machine learning and rules-based drilling data prediction.

FIG. 2 is a schematic diagram of an example system for training machine learning drilling models for drilling data correction.

FIG. 3 is a flowchart of example operations for correcting high-importance drilling data.

FIG. 4 is a flowchart of example operations for applying drilling data prediction criteria to outputs of machine learning and rules-based drilling models to generate corrected high-importance drilling data.

FIG. 5 depicts an example computer system with a drilling data correction system.

FIG. 6 is a schematic diagram of a drilling rig system with a drilling data correction system.

FIG. 7 depicts a schematic diagram of a wireline system with a drilling data correction system.

FIG. 8 is a flowchart of example operations for correcting drilling data with machine learning and rules-based predictions.

### DESCRIPTION OF EMBODIMENTS

The description that follows includes example systems, methods, techniques, and program flows that embody embodiments of the disclosure. However, it is understood that this disclosure may be practiced without these specific details. For instance, this disclosure refers to correction of drilling data using a machine learning drilling model and rules-based drilling model in illustrative examples. Embodiments of this disclosure can be instead applied to correcting any type of data using a machine learning model and a rules-based model. In other instances, well-known instruction instances, protocols, structures and techniques have not been shown in detail in order not to obfuscate the description.

Overview

A drilling data quality engine disclosed herein corrects high-importance drilling data using a combination of machine learning drilling models and rules-based drilling models. The machine learning drilling models are trained on impactful features of drilling data across a variety of sources and domains. The rules-based drilling models are determined by domain-level experts using knowledge of drilling operations. A data importance analyzer identifies high-importance drilling data including data segments that are known to have a high impact on drilling operations. The high-importance drilling data is input into the machine learning drilling models and rules-based models. A drilling data prediction analyzer determines which of the model outputs to use based on confidence values in the outputs of the machine learning drilling models and user input. The final predictions are evaluated for quality control and used to improve existing drilling data.

Example Illustrations

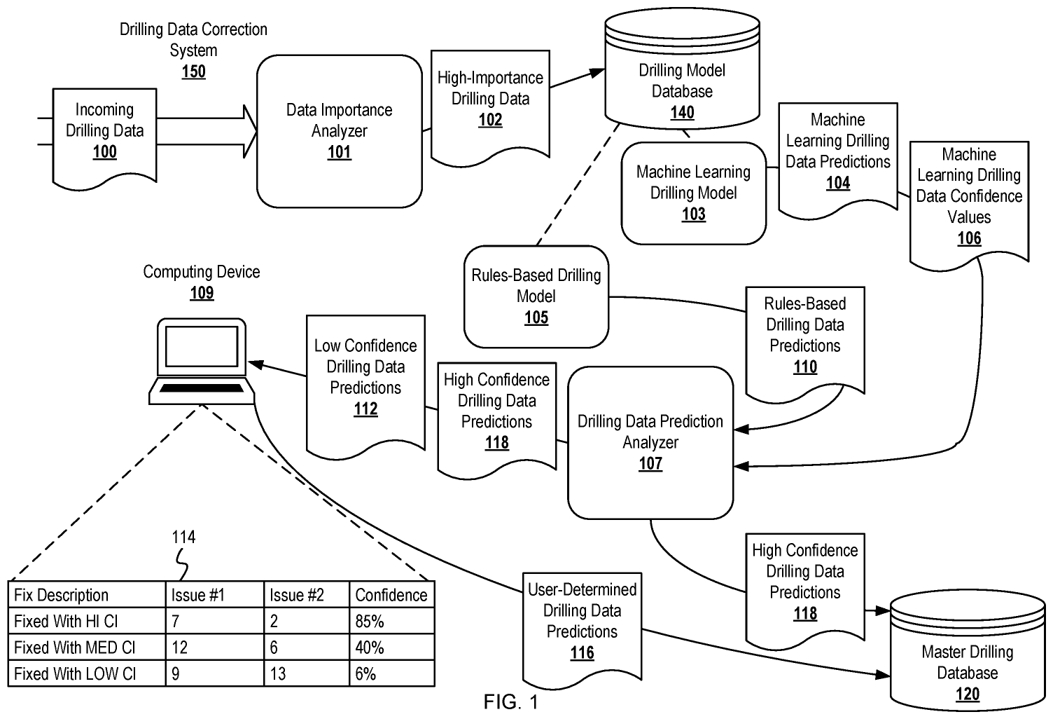

FIG. 1 is a schematic diagram of an example drilling data correction system that uses machine learning and rules-based drilling data prediction. A drilling data correction system 150 comprises a data importance analyzer 101 that receives incoming drilling data 100. The incoming drilling data 100 is typically data from a drilling operation and can comprise sensor data taken downhole or at the surface, manual inputs for operator data, inventory data, etc. The incoming drilling data 100 can be supplemented with data from a master drilling data repository (not depicted) to include metadata such as curve type (for curves of petrophysical properties downhole), curve name, log type, log activity, etc. The metadata can be maintained for a particular drilling operation or region of drilling operations to track key metrics related specifically to that drilling operation(s). The data importance analyzer 101 receives the incoming drilling data 100 and determines high-importance drilling data 102 subject to further quality control. The high-importance drilling data 102 is drilling data and drilling metadata that is important for efficiency and logistics of a drilling operation(s). The data importance analyzer 101 can use domain-level knowledge to determine key data segments in drilling data such as “curve units” corresponding to specific sections of petrophysical property curves downhole that are important for drilling operations. For instance, a curve unit can be a section of heat flow values downhole known to promote the presence of hydrocarbons. These curve units can be hard-coded into the data importance analyzer 101 and the data importance analyzer 101 can search the incoming drilling data 100 for curve units resembling the hard-coded curve units known to be high-importance.

The data importance analyzer 101 sends the high-importance drilling data 102 to a drilling model database 140 that retrieves a machine learning drilling model 103 and a rules-based drilling model 105. The high-importance drilling data 102 can instead be a query indicating the high-importance data segments and the drilling model database 140 can be indexed by data segment type/location to retrieve the corresponding models. The machine learning drilling model 103 generates machine learning drilling data predictions 104 and machine learning drilling data confidence values 106 using features of the incoming drilling data 100 as well as auxiliary supplemental drilling data as input. The rules-based drilling model 105 generates rules-based drilling data predictions 110 also using the incoming drilling data 100 and auxiliary drilling data. The machine learning drilling data predictions 104 and rules-based drilling data predictions 110 comprise predictions to verify the quality of the high-importance drilling data 102. The machine learning drilling data confidence values 106 comprise confidence values indicating likelihoods that each of the machine learning drilling data predictions 104 are correct. The machine learning drilling model 103 and/or rules-based drilling model 105 can be trained or configured to make predictions specifically for a high-importance data segment identified by the data importance analyzer 101. The high-importance drilling data 102 can have flaws in data entries within one or more high-importance data segments that a drilling data quality analyzer (not shown) can detect and send incoming drilling data 100 to the data importance analyzer 101 in response to detecting flawed data entries.

The drilling data prediction analyzer 107 receives the machine learning drilling data predictions 104, the machine learning drilling data confidence values 106, and the rules-based drilling data predictions 110. The drilling data prediction analyzer 107 then applies a series of criteria to determine which of the machine learning drilling data predictions 104 to use and which of the rules-based drilling data predictions to use. As depicted in FIG. 1, the drilling data prediction analyzer 107 segregates the machine learning drilling data predictions 104 into low confidence drilling data predictions 112 and high confidence drilling data predictions 118. The machine learning drilling data predictions 104 can be segregated based on, for instance, a threshold confidence value above which predictions are high confidence and below which predictions are low confidence. Other criteria include importance levels for each of the predictions (e.g., a lower importance prediction may have a lower confidence threshold because a user is willing to accept more error) or other user-specified criteria that can depend on the type of prediction. In some embodiments, when the rules-based drilling data predictions 110 are known to have high accuracy these can be used in place of machine learning drilling data predictions 104 with low confidence values in the high confidence drilling data predictions 118. The high confidence drilling data predictions 118 comprise, for each value of the high-importance drilling data 102, a drilling data prediction from either the machine learning drilling data predictions 104 or the rules-based drilling data predictions 110, whereas the low confidence drilling data predictions 112 comprise drilling data predictions from both the machine learning drilling data predictions 104 and rules-based drilling data predictions 110 so that a user can choose between them. The drilling data prediction analyzer 107 communicates the high confidence drilling data predictions 118 to a master drilling database 120 and both the high confidence drilling data predictions 118 and the low confidence drilling data predictions 112 to a computing device 109.

A user operating the computing device 109 evaluates the low confidence drilling data predictions 112 to determine the user-determined drilling data prediction 116. For instance, a user can be presented, via a user interface running on the computing device 109, machine learning drilling data predictions 104 and rules-based drilling data predictions 110 in the low confidence drilling data predictions 112 along with corresponding confidence values in the machine learning drilling data confidence values 106. The user chooses between the machine learning drilling data predictions 104 and rules-based drilling data predictions 110 using the given confidence values and known domain-level knowledge. For instance, the user can know thresholds or shapes of petrophysical property values downhole present in a machine learning prediction not present in a rules-based prediction, and can choose to add the machine learning prediction to the user-determined drilling data predictions 116. In some instances, the user can determine to use none of the low confidence drilling data predictions 112 and instead maintain the high-importance drilling data 102 in memory. The computing device 109 communicates the user-determined drilling data predictions 116 to the master drilling database 120 and the master drilling database replaces the corresponding values of the high-importance drilling data 102 in memory. Subsequently, the improved drilling data in the master drilling database 120 can be used to improve a machine learning drilling model in the drilling model database 140.

The computing device 109, based on the high confidence drilling data predictions 118 and the user-determined drilling data predictions 116, generates a quality control report such as the example quality control report 114. The example quality control report 114 is provided to a user interface by the computing device 109 and comprises the following table of values:

| Fix Description | Issue #1 | Issue #2 | Confidence |
|---|---|---|---|
| Fixed With HI CI | 7 | 2 | 85% |
| Fixed With MED CI | 12 | 6 | 40% |
| Fixed With LOW CI | 9 | N/A | 6% |

The table describes three drilling data fixes with attributes fix description, issue #1, issue #2, and confidence of fix. The first fix corrected issues 7 and 2 with high confidence of 85%. The second fix corrected issues 12 and 6 with medium confidence of 40%. The third fix corrected issue 9 with confidence of 6%. The confidence value in the example quality control report 114 can be a confidence value in the machine learning drilling data confidence values 106 corresponding to the respective fixes converted into a percentage. When the fix is rules-based (as determined by a user) the user can estimate the confidence percentage value based on the user's confidence in the rules-based prediction.

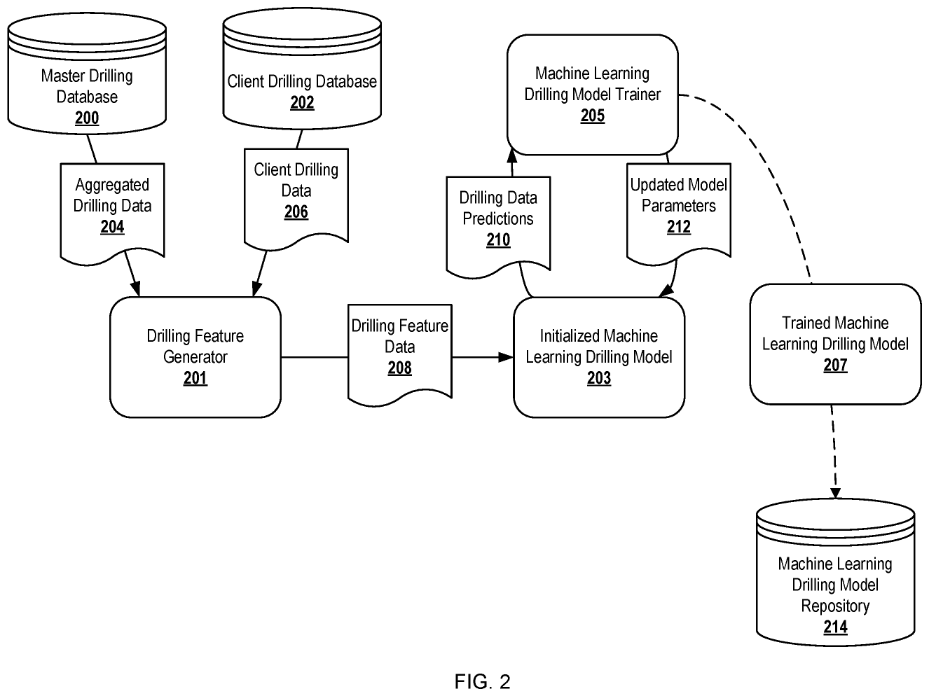

FIG. 2 is a schematic diagram of an example system for training machine learning drilling models for drilling data correction. A drilling feature generator 201 receives client drilling data 206 and aggregated drilling data 204 from a client drilling database 202 and a master drilling database 200, respectively. The master drilling database 200 can be a drilling database containing drilling data from across a lifetime of data aggregation at drilling operations around the world. The client drilling database 202 can be a database specific to a drilling operation or region for which drilling data will be corrected. The drilling data on the master drilling database 200 and client drilling database 202 can comprise sensor data from a borehole assembly downhole, surface measurements, operational data such as inventory, drilling task data, petrophysical data, metadata for any of the aforementioned data, etc. The aggregated drilling data 204 and client drilling data 206 can further include curve units corresponding to sections of petrophysical property curves downhole that have a high impact on drilling operations and other impactful metadata.

The drilling feature generator 201 determines drilling feature data 208 from the aggregated drilling data 204 and client drilling data 206. The drilling feature generator 201 can use standard statistical methods for feature selection such as information-theory based or correlation-based feature selection to determine features used to generate the drilling feature data 208. For instance, the drilling feature generator 201 can use Pearson correlation coefficients between candidate features and corresponding classifications for drilling data (e.g., correct or incorrect) to identify features that are correlated with correct or incorrect drilling data. In some embodiments, a domain-level expert can identify features such as curve units that are known to be of high importance or to have an effect or whether drilling data is correct. Once sufficiently many features are determined, for instance based on a user-specified input for a number of features or corresponding to complexity of a desired machine-learning model, the drilling feature generator 201 generates the drilling feature data 208 by applying the features to the aggregated drilling data 204 and client drilling data 206. For instance, the drilling feature generator 201 can extract curve units that are known to have high importance for drilling data being correct from petrophysical property data downhole in the aggregated drilling data 204 and client drilling data 206.

The drilling feature generator 201 sends the drilling feature data 208, after segregating into training and testing data, to an initialized machine learning drilling model 203 that was initialized by a machine learning drilling model trainer 205. The initialized machine learning drilling model 203 can have an architecture specified by a user or hard coded based on factors such as the complexity of the drilling data to be corrected. For instance, when the initialized machine learning drilling model 203 is a neural network, a user can specify the number of internal layers, type of internal layers, number of nodes in each layer, etc. for a neural network. The initialized machine learning drilling model 203 uses training data in the drilling feature data 208 to generate drilling data predictions 210. The machine learning drilling model trainer 205 compares the drilling data predictions 210 to correct drilling data in the aggregated drilling data 204 and the client drilling data 206 and, based on the difference, communicates updated model parameters 212 to the initialized machine learning drilling model 203. The machine learning drilling model trainer 205 continues to update parameters of the initialized machine learning drilling model 203 until the drilling data predictions 210 are sufficiently close to the corresponding correct drilling data or other training criteria are satisfied. For instance, the machine learning drilling model trainer 205 can input testing data in the drilling feature data 208 into the initialized machine learning drilling model 203 to determine generalization error, which can be required to be sufficiently low. Once the training criteria are satisfied, the machine learning drilling model trainer 205 stores a trained machine learning drilling model 207 in a machine learning drilling model repository 214.

The drilling data predictions 210 can correspond to a high-importance drilling data segment corresponding to a drilling attribute (e.g., a curve unit for a petrophysical property). Thus, the trained machine learning drilling model 207 can be trained to make predictions specifically for that data segment. The machine learning drilling model repository 214 can contain machine learning drilling models for all known high-importance data segments corresponding to a drilling operation or set of drilling operations. The trained machine learning drilling model 207 can be trained in response to the detection of a new high-importance data segment.

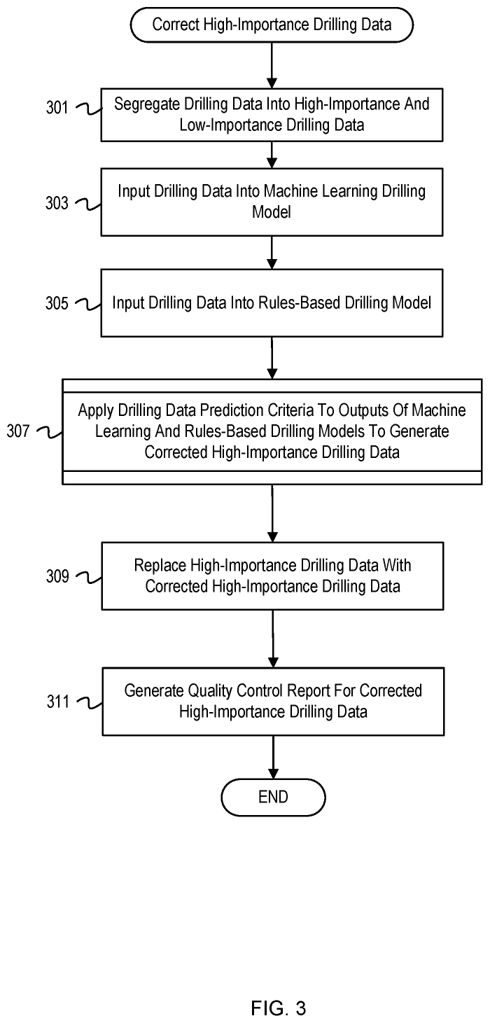

The example operations in FIGS. 3, 4, and 8 are described with reference to a drilling data correction system and a machine learning drilling model trainer for consistency with the earlier figures. The name chosen for the program code is not to be limiting on the claims. Structure and organization of a program can vary due to platform, programmer/architect preferences, programming language, etc. In addition, names of code units (programs, modules, methods, functions, etc.) can vary for the same reasons and can be arbitrary.

FIG. 3 is a flowchart of example operations for correcting high-importance drilling data. At block 301, a drilling data correction system segregates drilling data into high-importance and low-importance drilling data. The high-importance drilling data can correspond to data segments for a drilling attribute that are known to have high impact on drilling operations. For instance, high-importance drilling data can comprise a curve unit for a petrophysical property downhole. The drilling data correction system segregates the drilling data so that high-importance drilling data can be identified for additional quality control while it may not be worth using computing resources to correct low-importance drilling data.

At block 303, the drilling data correction system inputs drilling data into a machine learning drilling model. The machine learning drilling model can be trained to predict a high-importance data segment in the drilling data. Any predictive machine learning model such as k-means clustering, neural networks, support vector machines, etc. can be used. The drilling data correction system can preprocess the drilling data to extract meaningful features that have a high correlation with predicting a data segment (e.g., using Pearson correlation coefficients).

At block 305, the drilling data correction system inputs drilling data into a rules-based drilling model. The rules-based drilling model can comprise threshold values for petrophysical properties downhole or at the surface, inventory values, task-based descriptions, etc. For instance, the rules-based drilling model can threshold a heat flow value known to be too high for a specific drilling operation into a range of reasonable heat flow values as determined by an expert. The rules-based drilling model can additionally correct task-based drilling data by, for instance, replacing a task description with a task description in a list of known drilling task description for drilling operations.

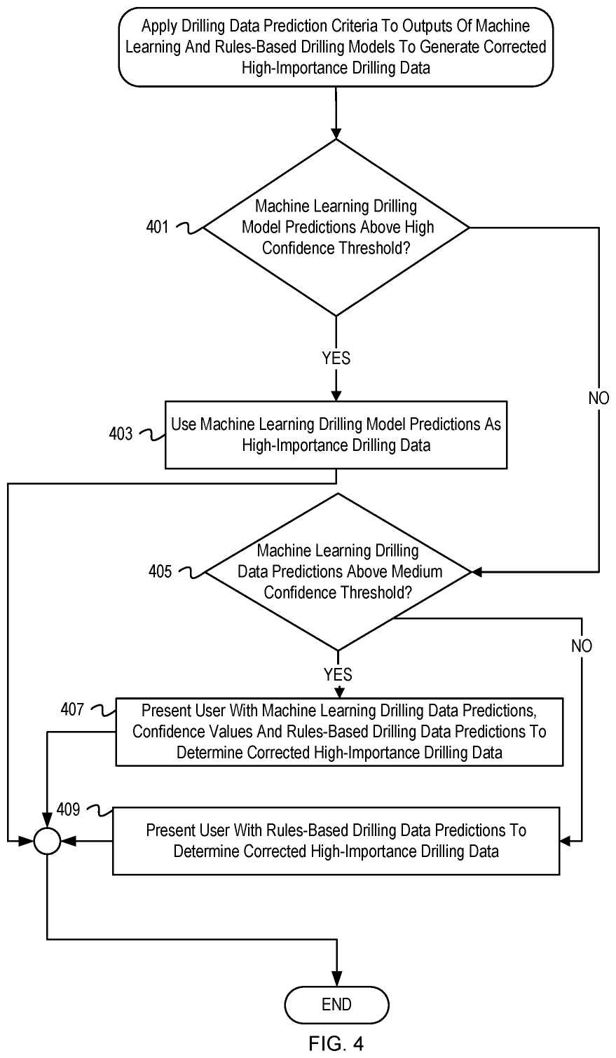

At block 307, the drilling data correction system applies drilling data prediction criteria to outputs of the machine learning and rules-based drilling models to generate corrected high-importance drilling data. The operations at block 307 are described in greater detail in FIG. 4.

At block 309, the drilling data correction system replaces high-importance drilling data with corrected high-importance drilling data. The drilling data correction system can use the corrected high-importance drilling data to improve machine learning drilling models and/or rules-based drilling models by, for instance, retraining models with the corrected high-importance drilling data.

At block 311, the drilling data correction system generates a quality control report for the corrected high-importance drilling data. The quality control report can comprise indications of drilling data entries that were corrected, the corrections, whether the machine learning drilling model outputs or rules-based drilling model outputs were used, whether a user decided which drilling model to use, confidence values for the corrections (e.g., in the machine learning drilling model outputs or indicated by a user), etc. The quality control report can be presented to a user and can comprise further analytics such as severity of corrections, frequency of corrections, importance of corresponding data segments, etc.

FIG. 4 is a flowchart of example operations for applying drilling data prediction criteria to outputs of machine learning and rules-based drilling models to generate corrected high-importance drilling data. The drilling data prediction criteria in FIG. 4 exemplify one possible set of criteria for combining or choosing outputs of drilling models. Other criteria, combinations of criteria, etc. can be implemented. At block 401, a drilling data correction system determines whether the machine learning drilling model predictions are above a high-confidence threshold. The high-confidence threshold can be a threshold confidence value (e.g., 0.9) and can be chosen by a user based on the desired level of confidence. The high-confidence threshold can depend on the importance of a data segment corresponding to the machine learning drilling model predictions (e.g., more important data segments have higher confidence thresholds). If the machine learning drilling model predictions are above the high confidence threshold, operations continue to block 403. Otherwise, operations skip to block 405.

At block 403, the drilling data correction system uses the machine learning drilling model predictions as high-importance drilling data. The drilling data correction system can automatically replace the high-importance drilling data with the machine learning drilling model predictions in memory without consulting a user because the confidence of the predictions is above the high-confidence threshold.

At block 405, the drilling data correction system determines whether the machine learning drilling data predictions are above a medium confidence threshold. The medium confidence threshold can be a confidence value below the high confidence threshold (e.g., 0.6) and can also be tuned by a user depending on many factors such as importance of a corresponding data segment, desired confidence level in drilling data corrections, importance of a corresponding drilling operation, etc. If the machine drilling data predictions are above the medium confidence threshold, operations proceed to block 407. Otherwise, operations skip to block 409.

At block 407, the drilling data correction system presents a user with machine learning drilling data predictions, confidence values, and rules-based drilling data predictions to determine corrected high-importance data. The user can determine which predictions to use as the corrected high-importance data based on a variety of factors including the confidence of the machine learning drilling data predictions, expert domain-level knowledge of the rules-based predictions, etc. For instance, a user can determine that a task description from a machine learning drilling data prediction is incorrect and can instead choose a rules-based task description. Conversely, a user can determine that a curve unit for heat flow in the machine learning drilling data predictions has a more accurate shape than curve units in the rules-based drilling data predictions.

At block 409, the drilling data correction system presents a user with the rules-based drilling data predictions to determine corrected high-importance drilling data. The drilling data correction system cannot present the user with machine learning drilling data predictions with confidence values that are too low (e.g., a threshold determined by the user). Conversely, the drilling data correction system can present the user with low confidence machine learning drilling data predictions along with indications warning the user that the predictions are low confidence. The user can make a determination of which predictions to use as the high-importance drilling data using any of the aforementioned factors.

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. For example, the operations depicted in blocks 303 and 305 can be performed in parallel or concurrently. With respect to FIG. 4, block 409 is not necessary. It will be understood that each block of the flowchart illustrations and/or block diagrams, and combinations of blocks in the flowchart illustrations and/or block diagrams, can be implemented by program code. The program code may be provided to a processor of a general-purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine-readable medium(s) may be utilized. The machine-readable medium may be a machine-readable signal medium or a machine-readable storage medium. A machine-readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine-readable storage medium would include the following: a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine-readable storage medium may be any tangible medium that can contain or store a program for use by or in connection with an instruction execution system, apparatus, or device. A machine-readable storage medium is not a machine-readable signal medium.

A machine-readable signal medium may include a propagated data signal with machine-readable program code embodied therein, for example, in baseband or as part of a carrier wave. Such a propagated signal may take any of a variety of forms, including, but not limited to, electro-magnetic, optical, or any suitable combination thereof. A machine-readable signal medium may be any machine-readable medium that is not a machine-readable storage medium and that can communicate, propagate, or transport a program for use by or in connection with an instruction execution system, apparatus, or device.

Program code embodied on a machine-readable medium may be transmitted using any appropriate medium, including but not limited to wireless, wireline, optical fiber cable, RF, etc., or any suitable combination of the foregoing.

The program code/instructions may also be stored in a machine-readable medium that can direct a machine to function in a particular manner, such that the instructions stored in the machine-readable medium produce an article of manufacture including instructions which implement the function/act specified in the flowchart and/or block diagram block or blocks.

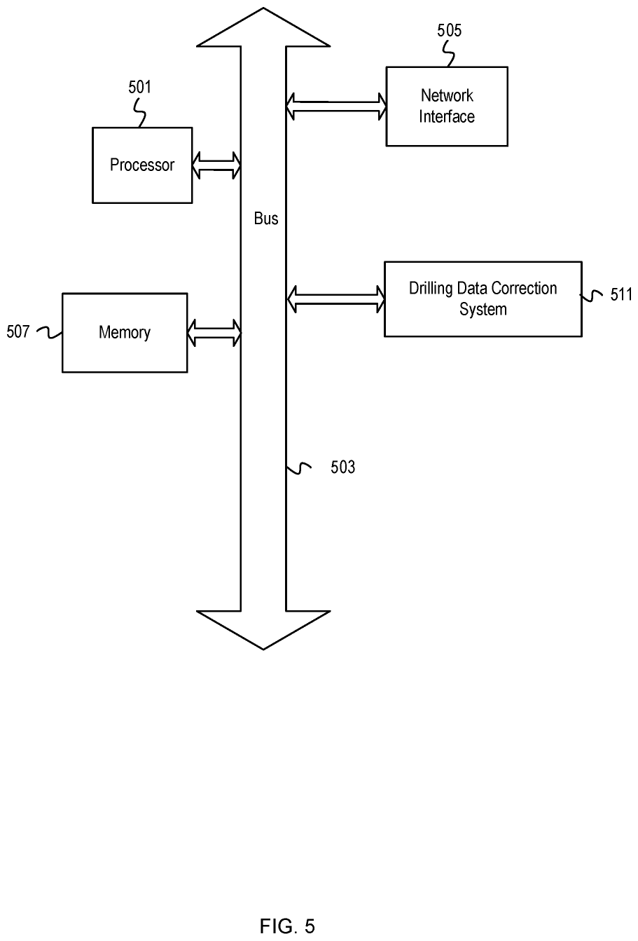

FIG. 5 depicts an example computer system with a drilling data correction system. The computer system includes a processor 501 (possibly including multiple processors, multiple cores, multiple nodes, and/or implementing multi-threading, etc.). The computer system includes memory 507. The memory 507 may be system memory or any one or more of the above already described possible realizations of machine-readable media. The computer system also includes a bus 503 and a network interface 505. The system communicates via transmissions to and/or from remote devices via the network interface 505 in accordance with a network protocol corresponding to the type of network interface, whether wired or wireless and depending upon the carrying medium. In addition, a communication or transmission can involve other layers of a communication protocol and or communication protocol suites (e.g., transmission control protocol, Internet Protocol, user datagram protocol, virtual private network protocols, etc.). The system also includes a drilling data correction system 511. The drilling data correction system 511 can identify high-importance data segments in drilling data and can generate candidate corrections for the high-importance data segments using a combination of a machine learning drilling model and a rules-based drilling model. Any one of the previously described functionalities may be partially (or entirely) implemented in hardware and/or on the processor 501. For example, the functionality may be implemented with an application specific integrated circuit, in logic implemented in the processor 501, in a co-processor on a peripheral device or card, etc. Further, realizations may include fewer or additional components not illustrated in FIG. 5 (e.g., video cards, audio cards, additional network interfaces, peripheral devices, etc.). The processor 501 and the network interface 505 are coupled to the bus 503. Although illustrated as being coupled to the bus 503, the memory 507 may be coupled to the processor 501.

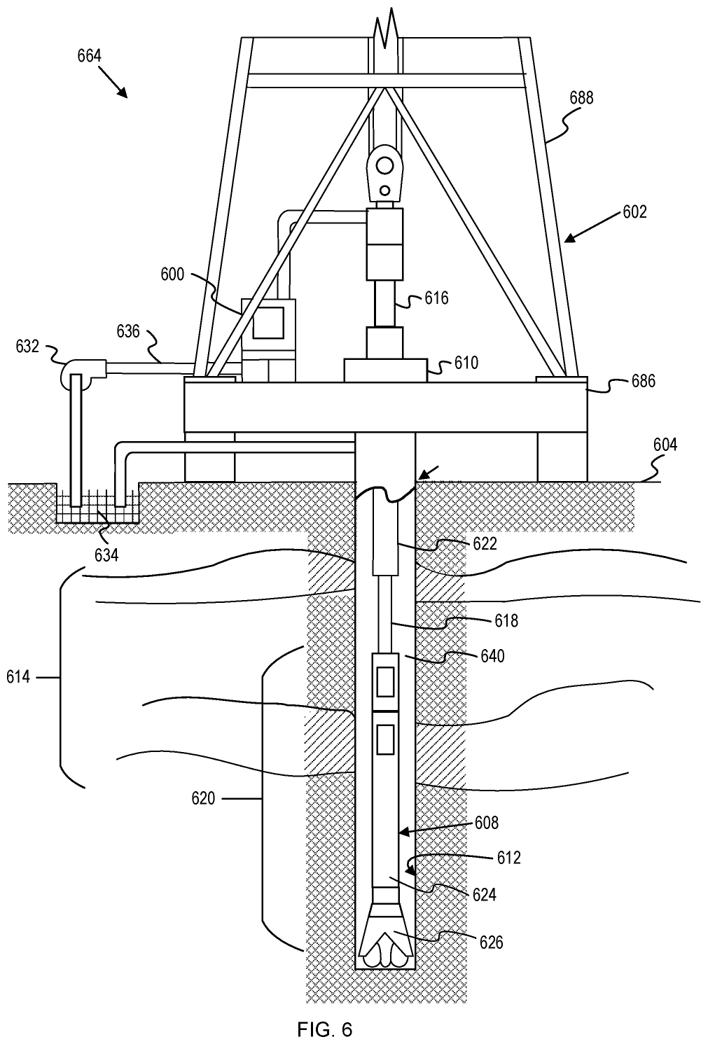

FIG. 6 is a schematic diagram of a drilling rig system with a drilling data correction system. For example, in FIG. 6 it can be seen how a system 664 may also form a portion of a drilling rig 602 located at the surface 604 of a well 606. Drilling of oil and gas wells is commonly carried out using a string of drill pipes connected together so as to form a drilling string 608 that is lowered through a rotary table 610 into a wellbore or borehole 612. A drilling platform 686 is equipped with a derrick 688 that supports a hoist. The drilling rig 602 can thus provide support for the drill string 608. The drill string 608 can operate to penetrate the rotary table 610 for drilling the borehole 612 through subsurface formations 614. The drill string 608 can include a Kelly 616, drill pipe 618, and a bottom hole assembly 620, perhaps located at the lower portion of the drill pipe 618. The bottom hole assembly 620 can include drill collars 622, a down hole tool 624, and a drill bit 626. The drill bit 626 can operate to create a borehole 612 by penetrating the surface 604 and subsurface formations 614. The down hole tool 624 can comprise any of a number of different types of tools including MWD tools, LWD tools, and others.

During drilling operations, the drill string 608 (perhaps including the Kelly 616, the drill pipe 618, and the bottom hole assembly 620) can be rotated by the rotary table 610. In addition to, or alternatively, the bottom hole assembly 620 can also be rotated by a motor (e.g., a mud motor) that is located down hole. The drill collars 622 can be used to add weight to the drill bit 626. The drill collars 622 may also operate to stiffen the bottom hole assembly 620, allowing the bottom hole assembly 620 to transfer the added weight to the drill bit 626, and in turn, to assist the drill bit 626 in penetrating the surface 604 and subsurface formations 614.

During drilling operations, a mud pump 632 can pump drilling fluid (sometimes known by those of ordinary skill in the art as “drilling mud”) from a mud pit 634 through a hose 636 into the drill pipe 618 and down to the drill bit 626. The drilling fluid can flow out from the drill bit 626 and be returned to the surface 604 through an annular area 640 between the drill pipe 618 and the sides of the borehole 612. The drilling fluid can then be returned to the mud pit 634, where such fluid is filtered. A computing device 600 can monitor the drilling fluid as it flows through the hose 636. The computing device 600 can be in communication with an operator and the operator can logs tasks performed by the system 664. A drilling data correction system running on the computing device 600 can identify high-importance data segments in drilling data logged by the computing device 600 and can use a combination of a machine learning drilling model and rules-based drilling model to generate candidate corrections for the high-importance data segments as described variously herein. In some embodiments, the drilling fluid can be used to cool the drill bit 626, as well as to provide lubrication for the drill bit 626 during drilling operations. Additionally, the drilling fluid can be used to remove subsurface formation 614 cuttings created by operating the drill bit 626. It is the images of these cuttings that many embodiments operate to acquire and process.

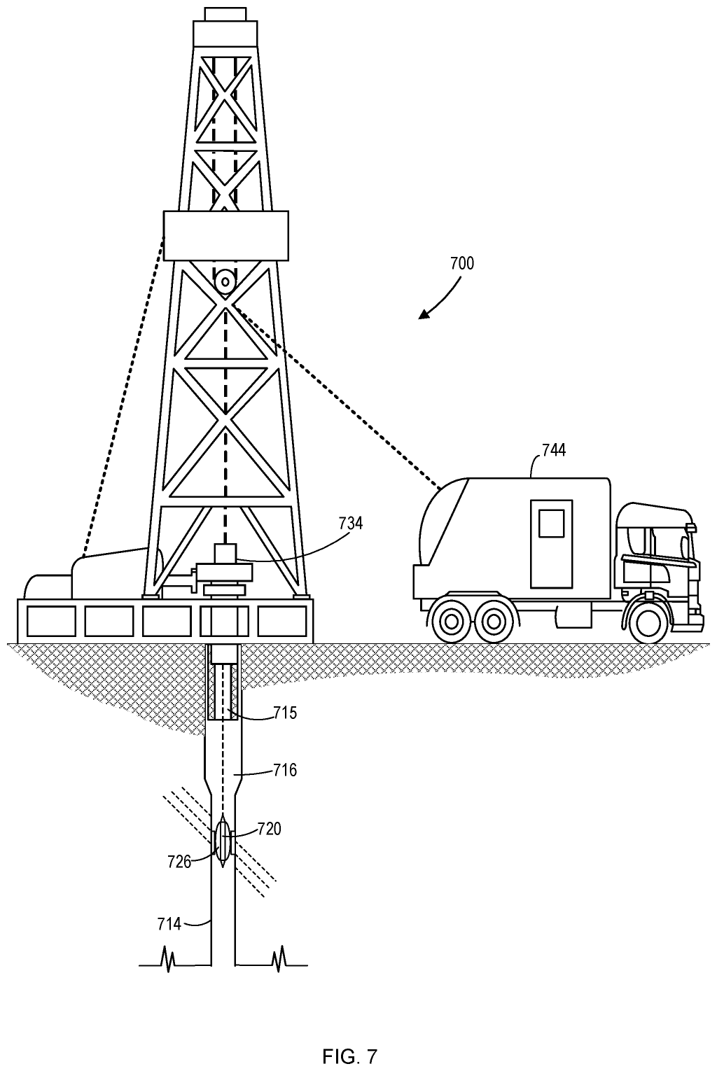

FIG. 7 depicts a schematic diagram of a wireline system with a drilling data correction system. A system 700 can be used in an illustrative logging environment with a drillstring removed, in accordance with some embodiments of the present disclosure. Subterranean operations can be conducted using a wireline system 720 once the drillstring has been removed, though, at times, some or all of the drillstring can remain in a borehole 714 during logging with the wireline system 720. The wireline system 720 can include one or more logging tools 726 that can be suspended in the borehole 714 by a conveyance 715 (e.g., a cable, slickline, or coiled tubing). The logging tool 726 can be communicatively coupled to the conveyance 715. The conveyance 715 can contain conductors for transporting power to the wireline system 720 and telemetry from the logging tool 726 to a logging facility 744. Alternatively, the conveyance 715 can lack a conductor, as is often the case using slickline or coiled tubing, and the wireline system 720 can contain a control unit 734 that contains memory, one or more batteries, and/or one or more processors for performing operations and storing measurements. The logging facility 744 can store data for tasks manually input by an operator of the system 700. A drilling data correction system running on the logging facility 744 can identify high-importance data segments in data logged by the logging facility 744 and can generate candidate corrections for the high-importance data segments to present to the operation of the system 700 using a combination of machine learning drilling models and rules-based drilling models.

In certain embodiments, the control unit 734 can be positioned at the surface, in the borehole (e.g., in the conveyance 715 and/or as part of the logging tool 726) or both (e.g., a portion of the processing can occur downhole and a portion can occur at the surface). The control unit 734 can include a control system or a control algorithm. In certain embodiments, a control system, an algorithm, or a set of machine-readable instructions can cause the control unit 734 to generate and provide an input signal to one or more elements of the logging tool 726, such as the sensors along the logging tool 726. The input signal can cause the sensors to be active or to output signals indicative of sensed properties. The logging facility 744 (shown in FIG. 7 as a truck, although it can be any other structure) can collect measurements from the logging tool 726, and can include computing facilities for controlling, processing, or storing the measurements gathered by the logging tool 726. The computing facilities can be communicatively coupled to the logging tool 726 by way of the conveyance 715 and can operate similarly to the control unit 734. In certain example embodiments, the control unit 734, which can be located in logging tool 726, can perform one or more functions of the computing facility.

The logging tool 726 includes a mandrel and a number of extendible arms coupled to the mandrel. One or more pads are coupled to each of the extendible arms. Each of the pads have a surface facing radially outward from the mandrel. Additionally, at least sensor disposed on the surface of each pad. During operation, the extendible arms are extended outwards to a wall of the borehole to extend the surface of the pads outward against the wall of the borehole. The sensors of the pads of each extendible arm can detect image data to create captured images of the formation surrounding the borehole.

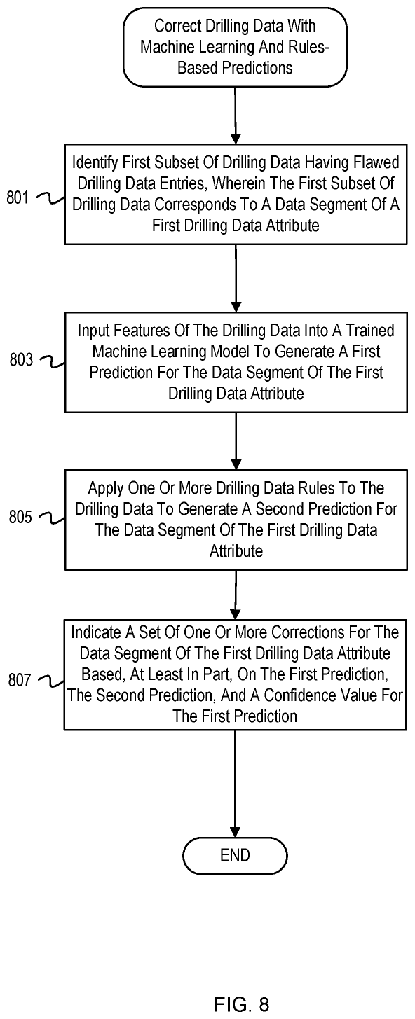

FIG. 8 is a flowchart that discloses the present technology in broader/distinct terminology as an attempt to account for the shortcoming of language to describe novel technology. For instance, the term “machine learning” is used to generically characterize a model implementing a statistical method of the field of machine learning regardless of internal architecture or model type. These flowcharts do not refer to a specific actor since there are numerous implementations for organizing and developing program code, as well as various choices for deployment on different hardware and/or virtualization.

FIG. 8 is a flowchart of example operations for correcting drilling data with machine learning and rules-based predictions. At block 801, a drilling data correction system identifies a first subset of drilling data having flawed drilling data entries, wherein the first subset of drilling data corresponds to a data segment of a first drilling data attribute. For instance, the first subset of drilling data can be one or more curve units for a petrophysical property curve downhole (e.g., heat flow). The curve unit can be determined based on operational knowledge of importance petrophysical property curves that have a high correlation for correcting data.

At block 803, the drilling data correction system inputs features of the drilling data into a trained machine learning model to generate a first prediction for the data segment of the first drilling data attribute. The features can comprise any number of drilling data or drilling metadata features that can be extracted prior to drilling data correction. These features can be determined empirically by measuring Pearson coefficients for correlations between inputting features into a trained machine learning model and generating corrected drilling data.

At block 805, the drilling data correction system applies one or more drilling data rules to the drilling data to generate a second prediction for the data segment of the first drilling data attribute. For instance, the rule can threshold petrophysical property values to be within a range of known operational petrophysical property values. Other conditions for different types of drilling data can be used, and the rules can be determined by a domain-level expert at a drilling operation corresponding to the drilling data.

At block 807, the drilling data correction system indicates a set of one or more corrections for the data segment of the first drilling data attribute based, at least in part, on the first prediction, the second prediction, and a confidence value for the first prediction. If the confidence value for the first prediction is sufficiently high, the drilling data correction system can correct the data segment of the first drilling data attribute as the first prediction. Otherwise, the drilling data correction system can present a combination of the first prediction and the second prediction to a user along with the confidence value for the first prediction to determine the correction.

While the aspects of the disclosure are described with reference to various implementations and exploitations, it will be understood that these aspects are illustrative and that the scope of the claims is not limited to them. In general, techniques for correcting high-importance drilling data segments using machine learning drilling models and rules-based drilling models as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

### Terminology

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

### Example Embodiments

Embodiment 1: A method comprising identifying a first subset of drilling data having flawed drilling data entries, wherein the first subset of drilling data corresponds to a data segment of a first drilling data attribute, inputting features of the drilling data into a trained machine learning model to generate a first prediction for the data segment of the first drilling data attribute, applying one or more drilling rules to the drilling data to generate a second prediction for the data segment of the first drilling data attribute, and indicating a set of one or more corrections for the data segment of the first drilling data attribute based, at least in part, on the first prediction, the second prediction and a confidence value for the first prediction.

Embodiment 2: The method of Embodiment 1 further comprising determining that the confidence value for the first prediction satisfies a confidence threshold and correcting flawed drilling data entries in the first subset of drilling data with the first prediction.

Embodiment 3: The method of any of Embodiments 1-2 further comprising determining that the confidence value for the first prediction does not satisfy a confidence threshold, determining that the second prediction satisfies a data quality criterion, and correcting flawed drilling data entries in the first subset of drilling data with the second prediction.

Embodiment 4: The method of any of Embodiments 1-3 further comprising generating drilling feature data based, at least in part, on a first plurality of features of a second subset of drilling data and generating the trained machine learning model to predict the data segment of the first drilling data attribute based, at least in part, on the drilling feature data.

Embodiment 5: The method of any of Embodiments 1-4, further comprising identifying the data segment of the first drilling data attribute based, at least in part, on flaws in the first subset of drilling data.

Embodiment 6: The method of any of Embodiments 1-5, wherein the data segment of the first drilling data attribute comprises a curve of petrophysical property values.

Embodiment 7: The method of any of Embodiments 1-6, further comprising updating the first subset of drilling data with at least a correction of the set of one or more corrections for the data segment of the first drilling data attribute.

Embodiment 8: The method of Embodiment 7, further comprising retraining the trained machine learning model using at least the updated first subset of drilling data.

Embodiment 9: One or more non-transitory machine-readable media comprising program to identify a first subset of drilling data having flawed drilling data entries, wherein the first subset of drilling data corresponds to a data segment of a first drilling data attribute, input features of the drilling data into a trained machine learning model to generate a first prediction for the data segment of the first drilling data attribute, apply one or more drilling rules to the drilling data to generate a second prediction for the data segment of the first drilling data attribute, and indicate a set of one or more corrections for the data segment of the first drilling data attribute based, at least in part, on the first prediction, the second prediction and a confidence value for the first prediction.

Embodiment 10: The non-transitory machine-readable media of Embodiment 9 further comprising program code to determine that the confidence value for the first prediction satisfies a confidence threshold and correct flawed drilling data entries in the first subset of drilling data with the first prediction.

Embodiment 11: The non-transitory machine-readable media of any of Embodiments 9-10 further comprising program code to determine that the confidence value for the first prediction does not satisfy a confidence threshold, determine that the second prediction satisfies a data quality criterion, and correct flawed drilling data entries in the first subset of drilling data with the second prediction.

Embodiment 12: The non-transitory machine-readable media of any of Embodiments 9-11 further comprising program code to generate drilling feature data based, at least in part, on a first plurality of features of a second subset of drilling data and generate the trained machine learning model to predict the data segment of the first drilling data attribute based, at least in part, on the drilling feature data.

Embodiment 13: The non-transitory machine-readable media of any of Embodiments 9-12, further comprising program code to identify the data segment of the first drilling data attribute based, at least in part, on flaws in the first subset of drilling data.

Embodiment 14: The non-transitory machine-readable media of any of Embodiments 9-13, wherein the data segment of the first drilling data attribute comprises a curve of petrophysical property values.

Embodiment 15: The non-transitory machine-readable media of any of Embodiments 9-14, further comprising program code to update the first subset of drilling data with at least a correction of the set of one or more corrections for the data segment of the first drilling data attribute.

Embodiment 16: The non-transitory machine-readable media of Embodiment 15, further comprising program code to retrain the trained machine learning model using at least the updated first subset of drilling data.

Embodiment 17: A apparatus comprising a processor, and a machine-readable medium having program code executable by the processor to cause the apparatus to identify a first subset of drilling data having flawed drilling data entries, wherein the first subset of drilling data corresponds to a data segment of a first drilling data attribute, input features of the drilling data into a trained machine learning model to generate a first prediction for the data segment of the first drilling data attribute, apply one or more drilling rules to the drilling data to generate a second prediction for the data segment of the first drilling data attribute, and indicate a set of one or more corrections for the data segment of the first drilling data attribute based, at least in part, on the first prediction, the second prediction and a confidence value for the first prediction.

Embodiment 18: The apparatus of Embodiment 17 further comprising program code executable by the processor to cause the apparatus to determine that the confidence value for the first prediction satisfies a confidence threshold and correct flawed drilling data entries in the first subset of drilling data with the first prediction.

Embodiment 19: The apparatus of any of Embodiments 17-18 further comprising program code executable by the processor to cause the apparatus to determine that the confidence value for the first prediction does not satisfy a confidence threshold, determine that the second prediction satisfies a data quality criterion, and correct flawed drilling data entries in the first subset of drilling data with the second prediction.

Embodiment 20: The apparatus of any of Embodiments 17-19 further comprising program code executable by the processor to cause the apparatus to generate drilling feature data based, at least in part, on a first plurality of features of a second subset of drilling data and generate the trained machine learning model to predict the data segment of the first drilling data attribute based, at least in part, on the drilling feature data.

What is claimed is:

1. A method comprising:
identifying a first subset of drilling data having flawed drilling data entries, wherein the first subset of drilling data corresponds to a data segment of a first drilling data attribute;
inputting features of the drilling data into a trained machine learning model to generate a first prediction for the data segment of the first drilling data attribute;
applying one or more drilling rules to the drilling data to generate a second prediction for the data segment of the first drilling data attribute; and
indicating a set of one or more corrections for the data segment of the first drilling data attribute based, at least in part, on the first prediction, the second prediction and a confidence value for the first prediction.

2. The method of claim 1 further comprising,
determining that the confidence value for the first prediction satisfies a confidence threshold; and
correcting flawed drilling data entries in the first subset of drilling data with the first prediction.

3. The method of claim 1 further comprising,
determining that the confidence value for the first prediction does not satisfy a confidence threshold;
determining that the second prediction satisfies a data quality criterion; and
correcting flawed drilling data entries in the first subset of drilling data with the second prediction.

4. The method of claim 1 further comprising,
generating drilling feature data based, at least in part, on a first plurality of features of a second subset of drilling data; and
generating the trained machine learning model to predict the data segment of the first drilling data attribute based, at least in part, on the drilling feature data.

5. The method of claim 1, further comprising identifying the data segment of the first drilling data attribute based, at least in part, on flaws in the first subset of drilling data.

6. The method of claim 1, wherein the data segment of the first drilling data attribute comprises a curve of petrophysical property values.

7. The method of claim 1, further comprising updating the first subset of drilling data with at least a correction of the set of one or more corrections for the data segment of the first drilling data attribute.

8. The method of claim 7, further comprising retraining the trained machine learning model using at least the updated first subset of drilling data.

9. One or more non-transitory machine-readable media comprising program to:
identify a first subset of drilling data having flawed drilling data entries, wherein the first subset of drilling data corresponds to a data segment of a first drilling data attribute;
input features of the drilling data into a trained machine learning model to generate a first prediction for the data segment of the first drilling data attribute;
apply one or more drilling rules to the drilling data to generate a second prediction for the data segment of the first drilling data attribute; and
indicate a set of one or more corrections for the data segment of the first drilling data attribute based, at least in part, on the first prediction, the second prediction and a confidence value for the first prediction.

10. The non-transitory machine-readable media of claim 9 further comprising program code to,
determine that the confidence value for the first prediction satisfies a confidence threshold; and
correct flawed drilling data entries in the first subset of drilling data with the first prediction.

11. The non-transitory machine-readable media of claim 9 further comprising program code to,
determine that the confidence value for the first prediction does not satisfy a confidence threshold;
determine that the second prediction satisfies a data quality criterion; and
correct flawed drilling data entries in the first subset of drilling data with the second prediction.

12. The non-transitory machine-readable media of claim 9 further comprising program code to,
generate drilling feature data based, at least in part, on a first plurality of features of a second subset of drilling data; and
generate the trained machine learning model to predict the data segment of the first drilling data attribute based, at least in part, on the drilling feature data.

13. The non-transitory machine-readable media of claim 9, further comprising program code to identify the data segment of the first drilling data attribute based, at least in part, on flaws in the first subset of drilling data.

14. The non-transitory machine-readable media of claim 9, wherein the data segment of the first drilling data attribute comprises a curve of petrophysical property values.

15. The non-transitory machine-readable media of claim 9, further comprising program code to update the first subset of drilling data with at least a correction of the set of one or more corrections for the data segment of the first drilling data attribute.

16. The non-transitory machine-readable media of claim 15, further comprising program code to retrain the trained machine learning model using at least the updated first subset of drilling data.

17. An apparatus comprising:
a processor; and
a machine-readable medium having program code executable by the processor to cause the apparatus to,
identify a first subset of drilling data having flawed drilling data entries, wherein the first subset of drilling data corresponds to a data segment of a first drilling data attribute;
input features of the drilling data into a trained machine learning model to generate a first prediction for the data segment of the first drilling data attribute;
apply one or more drilling rules to the drilling data to generate a second prediction for the data segment of the first drilling data attribute; and
indicate a set of one or more corrections for the data segment of the first drilling data attribute based, at least in part, on the first prediction, the second prediction and a confidence value for the first prediction.

18. The apparatus of claim 17 further comprising program code executable by the processor to cause the apparatus to,
determine that the confidence value for the first prediction satisfies a confidence threshold; and
correct flawed drilling data entries in the first subset of drilling data with the first prediction.

19. The apparatus of claim 17 further comprising program code executable by the processor to cause the apparatus to,
determine that the confidence value for the first prediction does not satisfy a confidence threshold;
determine that the second prediction satisfies a data quality criterion; and
correct flawed drilling data entries in the first subset of drilling data with the second prediction.

20. The apparatus of claim 17 further comprising program code executable by the processor to cause the apparatus to,
generate drilling feature data based, at least in part, on a first plurality of features of a second subset of drilling data; and
generate the trained machine learning model to predict the data segment of the first drilling data attribute based, at least in part, on the drilling feature data.
